(19) United States
(12) Patent Application Publication
(10) Pub. No.: US 2015/0035670 A1
(43) Pub. Date: Feb. 5, 2015

(54) DETECTION SYSTEM AND METHOD

(71) Applicant: 7680597 CANADA INC., Blainville (CA)

(72) Inventors: Daniel CYR, Blainville (CA); Aleksandar JOVANOVIC, Belgrade (RS)

(73) Assignee: 7680597 CANADA INC., Blainville (CA)

(21) Appl. No.: 13/955,014

(22) Filed: Jul. 31, 2013

(51) Int. Cl. G08B 29/18

(52) U.S. Cl. CPC G08B 29/185
USPC 340/506

(57) ABSTRACT

Method, processing node and system for triggering an appropriate action in a detection system. Data tuples comprising an emitter identifier and a timestamp sent from an emitter device are received at a processing node. A period between the timestamp of two of the data tuples provides an indication on status of the emitter device. The data tuples are stored into a memory module. A subset of the data tuples is read or queried from the memory module. The subset of the data tuples is analyzed to identify a pre-determined condition. The appropriate action is triggered when the pre-determined condition is met.

### TECHNICAL FIELD

The present invention relates to tracking movement and, more specifically, to tracking changes in motion and/or location using electromagnetic communication devices.

### BACKGROUND

Typically, a surveillance system includes different input means such as peripheral detectors, infrared detectors and video cameras. The security system triggers different alarms based on information received from the different input means. Unfortunately, false alarms are common in the typical surveillance system.

The present invention allows for reduction of false alarms in a surveillance system.

### SUMMARY

A first aspect of the present invention is directed to a method for triggering an appropriate action. The method comprises successively receiving data tuples, sent from an emitter device, comprising an emitter identifier and a timestamp, wherein a period between the timestamp of two of the data tuples provides an indication on status of the emitter device. The method further comprises storing the data tuples and the timestamp into a memory module, reading a subset of the data tuples from the memory module, analyzing the subset of the data tuples to identify a pre-determined condition and, when the pre-determined condition is met, triggering the appropriate action. Reading from the memory module may further comprise querying a database to read the data tuples.

The method may comprise granting an authorization request. The granted authorization request may be considered in the analysis of the subset of the data tuples.

The method may comprise filtering the received data tuples before storing the data tuples and the timestamp into a memory module.

The received data tuples may be further stored in a database and reading from the memory module further comprises querying the database. The data tuples stored in the database may be retrieved by the processing node.

The reading of the subset of the data tuples may comprise limiting the subset to an analysis period of time based on the timestamp and repeating the reading on a continuous basis. Receiving the data tuples and storing the data tuples may be performed on a continuous basis as long as the data tuples are received from the emitter device.

The indication of status may indicate movement of the emitter device. The period between the receptions of two of the data tuples may be higher when the status of the emitter device is idle. The period may be lower when the status of the emitter device is moving.

The pre-determined condition may be met when a number of consecutive data tuples from the subset during the analysis period of time are in the moving status.

The pre-determined condition may be met when a number of consecutive data tuples from the subset during the analysis period of time are in the moving status followed by absence of data tuples in one or more of following subsets. The appropriate action may comprise updating the status of the emitter device to “departed” and storing the updated status to the memory module.

The pre-determined condition may be met when a number of consecutive data tuples from the subset during the analysis period of time are in the moving status followed by a number of data tuples in one or more of following subsets in the idle status. The appropriate action may comprise updating the status of the emitter device to “arrived” and storing the updated status to the memory module.

The pre-determined condition may be met when a number of consecutive data tuples from the subset during the analysis period of time are in the idle status followed by absence of data tuples in one or more of following subsets. The appropriate action may comprise updating the status of the emitter device to “inconsistent” and storing the updated status to the memory module.

The appropriate action may be to trigger an alarm event for the emitter device and store an indication of the alarm event in the memory module.

At least one of the pre-determined condition or the appropriate action may be received from a secured authentication module following the granted authorization request. The granted authorization request may be valid for a limited time. The indication of status may indicate movement of the emitter device and the period between the receptions of two of the data tuples may be higher when the status of the emitter device is idle and the period may lower when the status of the emitter device is moving. The pre-determined condition may be met when a number of consecutive data tuples from the subset during the analysis period of time are in the moving status and the limited time elapses before renewal of the authorization request.

The data tuples may each further comprise a value derived from an accelerometer of the emitter device and a value derived from a battery meter of the emitter device.

The reception of the data tuples sent from the emitter device may be performed within a limited monitored premise by an antenna connected to a remote receiver using a low power wireless protocol. The remote receiver may forward the data tuples over a packet switched network to a processing node that performs the storage, reading and analysis thereof.

A second aspect of the present invention is directed to a processing node for triggering an appropriate action. The processing node comprises a filter module, a memory module and a correlation module. The filter module is for successively receiving data tuples, sent from an emitter device, comprising an emitter identifier and a timestamp. A period between the timestamp and two of the data tuples provides an indication on status of the emitter device. The memory module is for storing the data tuples. The correlation module is for storing the data tuples and the timestamp into a memory module, reading a subset of the data tuples from the memory module, analyzing the subset of the data tuples to identify a pre-determined condition and, when the pre-determined condition is met, triggering the appropriate action.

The reading by the correlation module may comprise limiting the subset to an analysis period of time based on the timestamp and may comprise repeating the reading on a continuous basis. Receiving the data tuples and storing the data tuples may be performed on a continuous basis as long as the data tuples are received from the emitter device.

The indication of status may indicate movement of the emitter device. The period between the receptions of two of the data tuples may be higher when the status of the emitter device is idle. The period may be lower when the status of the emitter device is moving.

The pre-determined condition may be met when a number of consecutive data tuples from the subset during the analysis period of time are in the moving status.

The appropriate action may be to trigger an alarm event for the emitter device and store an indication of the alarm event in the memory module.

The pre-determined condition may be met when a number of consecutive data tuples from the subset during the analysis period of time are in the moving status followed by absence of data tuples in one or more of following subsets. The appropriate action may comprise updating the status of the emitter device to “departed” and storing the updated status to the memory module.

The pre-determined condition may be met when a number of consecutive data tuples from the subset during the analysis period of time are in the moving status followed by a number of data tuples in one or more of following subsets in the idle status. The appropriate action may comprise updating the status of the emitter device to “arrived” and storing the updated status to the memory module.

The pre-determined condition may be met when a number of consecutive data tuples from the subset during the analysis period of time are in the idle status followed by absence of data tuples in one or more of following subsets. The appropriate action may comprise updating the status of the emitter device to “inconsistent” and storing the updated status to the memory module.

The data tuples may each further comprise a value derived from an accelerometer of the emitter device and a value derived from a battery meter of the emitter device.

The received data tuples may be further stored in a database. The data tuples stored in the database may be retrieved by the processing node and reading from the memory module may further comprise querying the database.

The correlation module may further filter the received data tuples before storing the data tuples and the timestamp into the memory module.

A third aspect of the present invention is directed to a system for triggering an appropriate action. The system comprises an emitter device for transmitting data tuples. The system further comprises a reader for receiving the data tuples and transmitting the data tuples over a network. The system further comprises a processing node that successively receives data tuples, sent from an emitter device, comprising an emitter identifier and a timestamp. A period between the timestamp and two of the data tuples provides an indication on status of the emitter device. The processing node stores the data tuples and the timestamp and reads a subset of the data tuples from a memory module. The processing node further analyzes the subset of the data tuples to identify a pre-determined condition. When the pre-determined condition is met, the processing node triggers the appropriate action.

Reading the subset of the data tuples may comprise limiting the subset to an analysis period of time based on the timestamp. The reading may further comprise repeating the reading on a continuous basis. Receiving the data tuples and storing the data tuples may be performed on a continuous basis as long as the data tuples are received from the emitter device.

The indication of status may indicate movement of the emitter device. The period between the receptions of two of the data tuples may be higher when the status of the emitter device is idle. The period may be lower when the status of the emitter device is moving.

The pre-determined condition may be met when a number of consecutive data tuples from the subset during the analysis period of time are in the moving status.

The appropriate action may be to trigger an alarm event for the emitter device and may be to store an indication of the alarm event in the memory module.

The pre-determined condition may be met when a number of consecutive data tuples from the subset during the analysis period of time are in the moving status followed by absence of data tuples in one or more of following subsets. The appropriate action may comprise updating the status of the emitter device to “departed” and storing the updated status to the memory module.

The pre-determined condition may be met when a number of consecutive data tuples from the subset during the analysis period of time are in the moving status followed by a number of data tuples in one or more of following subsets in the idle status. The appropriate action may comprise updating the status of the emitter device to “arrived” and storing the updated status to the memory module.

The pre-determined condition may be met when a number of consecutive data tuples from the subset during the analysis period of time are in the idle status followed by absence of data tuples in one or more of following subsets The appropriate action may comprise updating the status of the emitter device to “inconsistent” and storing the updated status to the memory module

The system may further comprise a secured authentication module for granting an authorization request. The granted authorization request may be considered in the analysis of the subset of the data tuples. The granted authorization request may be valid for a limited time. The indication of status may indicate movement of the emitter device. The period between the receptions of two of the data tuples may be higher when the status of the emitter device is idle. The period may be lower when the status of the emitter device is moving. The pre-determined condition may be met when a number of consecutive data tuples from the subset during the analysis period of time are in the moving status and the limited time elapses before renewal of the authorization request.

The data tuples may each further comprise a value derived from an accelerometer of the emitter device and may comprise a value derived from a battery meter of the emitter device.

The received data tuples may be further stored in a database and reading from the memory module may further comprise querying the database.

The data tuples stored in the database may be retrieved by the processing node.

The processing node may further filter the received data tuples before storing the data tuples and the timestamp into a memory module.

The reader may comprise an antenna connected to a remote receiver using a low power wireless protocol for receiving, within a limited monitored premise, the data tuples sent from the emitter device. The remote receiver may forward the data tuples over a packet switched network to the processing node that may perform the storage, reading and analysis thereof.

### BRIEF DESCRIPTION OF THE DRAWINGS

Further features and exemplary advantages of the present invention will become apparent from the following detailed description, taken in conjunction with the appended drawings, in which:

FIG. 1 is a logical and modular representation of an exemplary network architecture in accordance with the teachings of the present invention;

FIG. 2 is a flow chart of an exemplary method in accordance with the teachings of the present invention; and

FIG. 3 is a logical and modular representation of a finite state machine of an exemplary method in accordance with the teachings of the present invention.

### DETAILED DESCRIPTION

Low-power emitter devices periodically transmit a limited set of information, or data tuple, on one or more pre-determined radio frequencies (RFs). The emitter devices could be Radio-frequency identification (RFID) tags. The emitted data tuples are received by one or more base stations that transmit the received data tuples over a network interface towards one or more processing node. The base stations are typically installed on a specific monitored premise having a set of emitter devices associated therewith while the processing node is located off-site. The base stations typically retransmit only the data tuples that match a pre-determined tuple format and filter out ambient RF noise (e.g., format filtering or parsing may be applied). The processing node receives the data tuples over a network interface and stores at least a subset of the data tuples in a memory module (e.g., format filtering or parsing may be applied). Data tuples that may be rejected at this stage may still further be stored in a memory module for analysis (e.g., in a different dataset). The processing node analyses the data tuples to identify surveillance patterns. The identified surveillance patterns may then be further correlated and may be used to trigger appropriate surveillance events (particular data logging, maintenance flags, information diffusion (email, SMS, etc.), conventional alarm, etc.)

For instance, failure to receive an expected data tuple related to a specific emitter device may indicate that the specific emitter device has left the monitored premise. However, failure to receive expected data tuples from every expected emitter device associated to the monitored premise likely indicates a system failure. While both surveillance patterns may represent relevant surveillance events, correlating the received data tuples and/or surveillance patterns provides additional surveillance information.

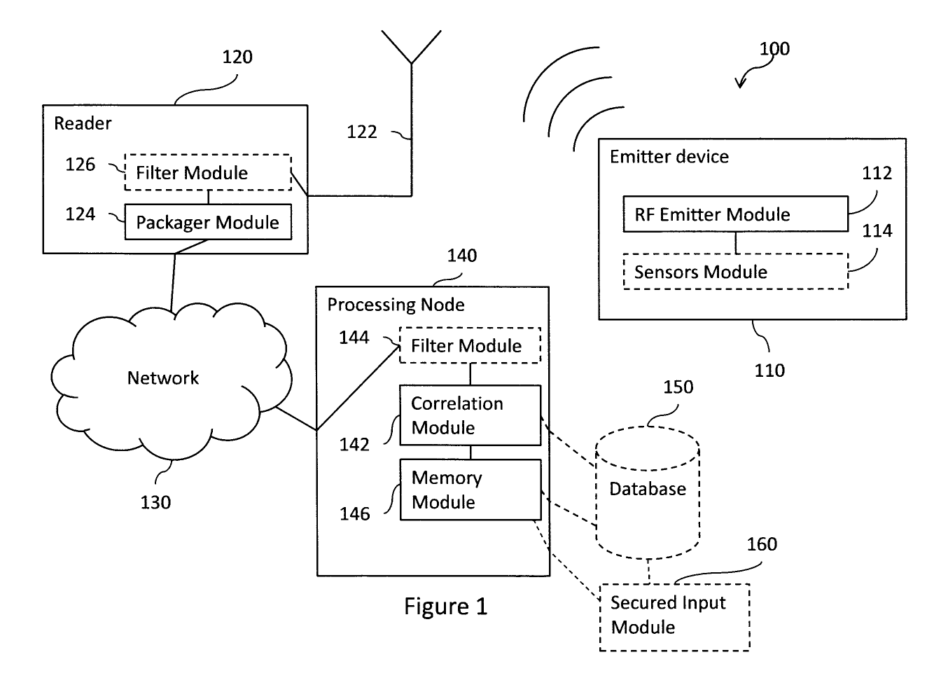

Reference is now made to the drawings in which FIG. 1 shows a logical and modular representation of exemplary network architecture 100 in accordance with the teachings of the present invention. The network architecture 100 comprises an emitter device 110, a reader 120, a network 130, a processing node 140 and a secured input module 160. The network architecture 100 may also comprise a database 150.

The emitter device 110 comprises an RF emitter module 112 that periodically transmits a data tuple over one or more frequency. In a preferred embodiment, the RF emitter module 112 transmits over the Industrial, Scientific and Medical (ISM) radio band centered on 433.92 MHz (1.84 MHz bandwidth). The RF emitter module 112 is shown without a dedicated antenna, but skilled persons will appreciate that one or more antennas could be provided based on the context of use of the present invention. The RF emitter module 112 is expected to be discernible in the example of FIG. 1 in a range of around 15 meters (50 feet). In a preferred embodiment, the emission power of the RF emitter module 112 is below or in the range of 300 μW.

The emitter device 110 may also comprise a sensors module 114 that may provide to and/or receive information from the RF emitter module 112. The emitter device 110 also comprises a processor module (not shown) and a memory module (not shown). The processor module and the memory module allow for general functions of the emitter device 110 to be fulfilled and may further provide an interface between the RF emitter module 112 and the optional sensors module 114.

The emitter device 110 further comprises a power source (not shown). The power source could be a battery of various technology (rechargeable (e.g., by wires or induction) or non-rechargeable), a solar panel that complements and/or replaces the battery and/or an interface for an external power device, which may further require a transformer. Skilled persons will readily understand that the power source does not affect the teachings of the present invention and that the power source should be selected based on the context of use of the present invention. For instance, in the preferred embodiment, the power source is a non-rechargeable lithium battery that is expected to last between 3 and 6 years.

The data tuple sent periodically from the RF emitter module 112 may comprise an identifier of the emitter device 110 and a timestamp (relative, absolute, incremental count, algorithm-based increment, etc.). Each data tuple may contain the same information (e.g., fixed data structure) or the data tuple may be dynamic and further comprise a header. The period between each data tuple may be set to a wide range of values (e.g., from 0.1 seconds to 20 minutes), based on the context of use of the present invention. In the preferred embodiment, a period of approximately 0.60 seconds between each data tuple in a normal mode of operation is expected to be sufficient.

The sensors module 114 may comprise an accelerometer, a thermometer, a battery meter, an air quality sensor, an atmospheric and/or depth pressure meter, a hygrometer, a Geiger counter, a positioning chip (e.g., Global Positioning System), a tampering detector, etc. The number of modules provided by the sensors module 114 and related power as well as data consumption should be carefully considered based on the context of use of the present invention. In a preferred embodiment, an expected data tuple capacity of 20 bytes has been determined for transmission by the RF emitter module 112 every 0.60 seconds.

In a preferred embodiment, the sensors module 114 comprises an accelerometer (or inertial sensor) and a battery meter. Each data tuple contains the identifier of the emitter device 110, the timestamp, a value derived from the accelerometer and a value derived from the battery meter. In addition, upon sensing a movement above a predetermined threshold with the accelerometer, the period at which the RF emitter module 112 sends the data tuple is decreased to approximately 0.15 seconds during 1 second (e.g., the emitter device 110 is in a burst mode as long as the accelerometer detects a movement above the threshold moves and for one more second). In a preferred embodiment, a detected tampering attempt may result in a third period (e.g., 0.10 seconds) being used for a given length of time (e.g., 1 minute). The data tuple may or may not contain information about the tampering attempt and the change in the period to a third value may be the actual information vector for the tampering attempt. Persons skilled in the art will readily understand that the examples provided concerning the emitter device 110 with reference to preferred embodiments are meant to illustrate the teachings of the present invention.

The reader 120 comprises an antenna module 122, a packager module 124 and may also comprise a filter module 126. The reader 120 uses the antenna module 122 to monitor or to listen to one or more RF. The antenna module 122 is illustrated in the example of FIG. 1 as an omnidirectional antenna, but a directional antenna or an array of directional and/or omnidirectional antennas may also be used. Skilled persons will readily understand how to design desired coverage for a physical premise, knowing the RF characteristics of the emitter device 110.

The reader 120 may also comprise an amplifier module (not shown), a processor module (not shown) and a memory module (not shown). The processor module and the memory module allow for general functions of the reader 120 to be fulfilled and further provide an interface between the antenna module 122, the packager module 124 and the optional filter module 126. The reader 120 also comprises an interface (not shown) with the antenna module 122 (e.g., a serial interface over an RS-232 serial port or a coaxial feed line) and a network interface (not shown) with the network 130 (e.g., an Ethernet interface supporting the IPv4 and/or IPv6 protocol(s)).

The filter module 126 may be used to apply one or more band filters on the feed line from the antenna module 122 on one or more predetermined frequencies or frequency ranges. The filter module 126 may also filter or parse the received raw data to extract only data tuples of predetermined format (e.g., expected preamble, gap and/or header, etc.) for consideration by the packager module 124. The filter module 126 may yet also be used to filter the received raw data to extract only data tuples related to a limited set of emitter devices for consideration by the packager module 124 (e.g., filtering on expected identifiers from emitter devices associated to the monitored premise).

The packager module 124 receives the data tuple emitted from the emitting device 100 (e.g., via the filter module 126 or not) and, in a preferred embodiment, encapsulates the data tuples into packets addressed to the processing node 140 via the network 130. The packets may further comprise additional time-related information and/or signal strength information that may have been added by the filter module 126 or generated at the packager module 124. Additional information may be particularly useful, especially when multiple antennas are provided by the antenna module 122, to obtain an approximate location of the emitter device 100 (e.g., knowing the location of the antennas and the characteristics of the premise). Skilled persons will understand that different protocols (e.g., dedicated/proprietary, standardized or not) could be used to ensure a data connection between the reader 120 and the processing node 140 and that the network 130 is shown as one possibility for illustrative purposes only. More specifically, in the example of FIG. 1, the reader 120 receives Internet Protocol (IP) connectivity (e.g., via a local area network (LAN) or a wireless LAN connection) and is able to exchange information with the processing node 140 via the network 130. It can also be appreciated that, in a simpler embodiment, the antenna module 122 could be connected directly to the processing node 140 (not shown) and, while such a system would present a scalability challenge, it would not affect the teachings of the present invention. Connectivity of the reader 120 to the network 130 and particularly to the network 130 using IP presents some exemplary advantages for ease of deployment and scalability, but skilled persons will understand that other possibilities are available that do not affect the present invention.

The processing node 140 comprises a correlation module 142 that may interact with the database 150, a memory module 146 which may interact with the database 150 and may also comprise a filter module 144 that may also interact with the database 150. The correlation module 142 interacts with the memory module 146. The filter module 144 may also interact with the memory module 146. The processing node 140 further comprises a processor module (not shown). The processor module and the memory module 146 allow for general functions of the processing node 140 to be fulfilled and further provide an interface between the correlation module 142 and the optional filter module 144. The memory module 146 stores the data tuples in order to be processed. The data tuples may be further stored in the database 150 and reading the data tuples from the memory module 146 may further involve querying the database 150 and further storing the queried data tuples into the memory module 146. The data tuples are read from the memory module 146 in order to determine if an event has taken place. In a preferred embodiment of the present invention, the memory module 146 may be random-access memory (RAM). Persons skilled in the art will readily recognize that the memory module 146 may also be other means for storing and reading data tuples.

The processing node 140 also comprises a network interface (not shown) with the network 130 (e.g., an Ethernet interface supporting the IPv4 and/or IPv6 protocol(s)). In a preferred embodiment, the network interface receives the packets from the packager module 124 through the network 130, decapsulates the packets and provides the data tuples seamlessly to the filter module 144 and/or the correlation module 142.

The filter module 144 may be used to filter or parse the received data tuples, e.g., to remove data tuples that are not formatted as expected or not from an expected emitter device (not shown). The filtered data tuples may still be stored in the memory module 146 (e.g., in an exception dataset) and/or sent or later accessed by the correlation module 142 as they may indicate tampering attempts, system failures or other unexpected conditions.

The correlation module 142 stores the received data tuples into the memory module 146 (e.g., in a regular dataset) and/or reads them from the memory module 146 to identify surveillance patterns. The identified surveillance patterns may then be further correlated and may be used to trigger appropriate surveillance events (particular data logging, maintenance flags, information diffusion (email, SMS, etc.), conventional alarm, etc.). Additional details on surveillance patterns and surveillance events are provided in relation to other Figures.

In the example of FIG. 1, the processing node 140 is shown as a separate physical node. Skilled persons will understand that the processing node 140 could be implemented as a logical partition on a larger physical node or cluster of physical nodes (e.g., implemented as a processing service from a cloud computing provider).

The database 150 may store data tuples received from the correlation module 144 or from the memory module 146. The data tuples stored in the database 150 may be retrieved by the processing node 140 in order to perform multiple functions, such as statistical correlations, verification of received data tuples over a longer period of time, building a larger dataset, e.g., for training artificial intelligence or for other functions involving surveillance patterns. Persons ordinarily skilled in the art will understand that the data tuples stored in the database 150 may be used for many other functions. Skilled persons will also understand that the stored data tuples may be retrieved by other devices than the processing node.

The database 150 could be structured using a relational database protocol (e.g., Structured Query Language variant such as MySQL™). In the example of FIG. 1, the database 150 is shown as a separate storage device. The processing node 140 and the database 150 may also be collocated in a single physical node. Skilled persons will understand that the database 150 could also be implemented as a logical partition on a larger physical node or cluster of physical nodes (e.g., implemented as a storage service from a cloud storage provider).

The secured input module 160 may serve as a terminal to modify the systems behavior. The secured input module 160 may require prior user authorization, which could be provided, for instance, by a username and password combination, a biometric reading (iris scan or recognition, fingerprint, handprint, facial scan or recognition, etc.), voice/writing recognition or any combination thereof. The secured input module 160 may also be configured to log a security incident based on a configurable number of failed authorization attempts and/or based on a level of failure to satisfy the required level of recognition (e.g., every authorization attempt is rated with a score with a minimum score threshold set for a successful authorization and if the level is considerably lower than a configurable minimum). An image (fingerprint, iris, face, etc) may also be stored with the incident by the secured input module 160.

Once authorized, the system's triggers or general behaviors may be changed, for instance, to indicate an expected behavior of the emitter device 100, thereby disabling some or all of the surveillance events that could otherwise be triggered by the emitter device 110. More specifically, the secured input module 160 may be used to indicate that the emitter device 110 is expected to move in the next 15 minutes. The indication may be stored in the memory module 146 and further used by the correlation module 142. Skilled persons will understand that the indication may also be stored in the database 150. The processing node 140 may further trigger a warning message (email, SMS, etc.) at one or more time thresholds (every 5 minutes) to the user that provided the indication through the secured input module 160 and/or to one or more dedicated contact points (e.g., administrator, manager, etc.). One or more receivers of the warning message may further extend the expected period by replying thereto (e.g., using a link provided in the message or a predetermined code or expression).

The secured input module 160 may also serve to add one or more alert conditions in the memory module 146. The alert conditions could be set for individual emitter devices or for the monitored premise. For instance, an alert condition could be a monitored premise based on time of day or day of week. An example would be to set alert conditions differently for two emitter devices being used in a car compared to being used on an inventory asset (e.g., a computer server) on the same monitored premise. Skilled persons will understand that the alert conditions may also be stored in the database 150.

In the example of FIG. 1, the secured input module 160 is shown connected directly to the memory module 146. In this example, the secured input module 160 is thus able to store and retrieve information from the memory module 146 using appropriate protocols. As shown in FIG. 1, the secured input module 160 may also be connected to the database 150. In this exemplary embodiment, it is to be understood that the processing node 140 or any other node (not shown) may serve as the interface towards the database 150 (e.g., via a web-type server having server-side script capabilities).

In a preferred embodiment of the present invention, the processing node 140 runs different processes in parallel and is able to act, for instance, in the role of receiver of the data tuples towards the database 150 for storage as well as in the role of analyzer of the stored data tuples retrieved from the database 150. Skilled persons will understand that the different processes could be implemented using a different architecture (not shown) that involves different nodes (not shown), which could be useful to enhance load distribution or fault tolerance, for instance.

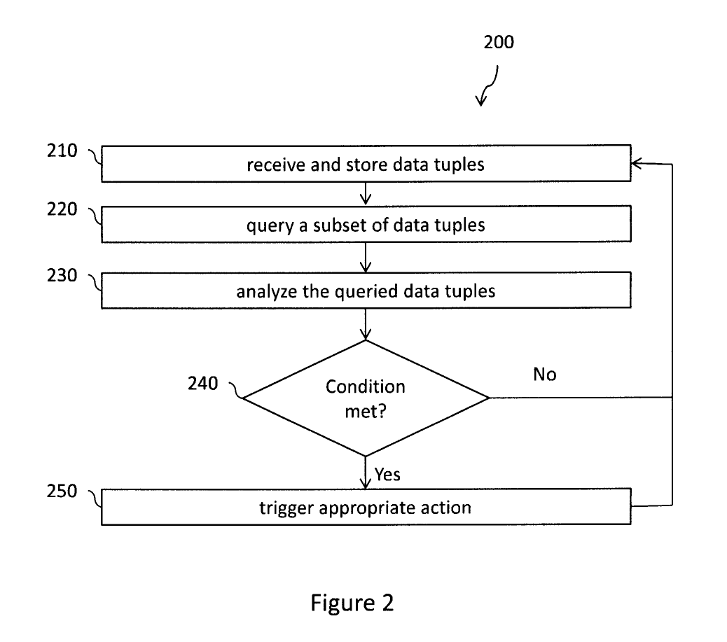

FIG. 2 shows a flow chart of a method 200 in accordance with the teachings of the present invention. The example of FIG. 2 begins with receiving, through a network, and storing, in a memory module, a plurality of data tuples related to a plurality of emitter devices (210). A subset of the data tuples is then read (or queried, fetched) from the memory module (220). The subset can relate, for instance, to the monitored premise (e.g., data tuples related to all emitter devices of a monitored premise), to a subset of emitter devices (e.g., data tuples related to all emitter devices expected to be on the monitored premise) or to a specific emitter device. The read or query may also further be limited to a number of data tuples (e.g., latest 75 data tuples received), to a period of time (e.g., all data tuples received in the last five minutes or between specific date/times) or to specific content (e.g., all data tuples for a monitored premise that indicate lower battery charge). Of course, it is understood that other queries can be made to answer specific needs, e.g., matching different alert conditions that could be set.

The read or queried subset of data tuples is then analyzed (230) and if at least one of different predetermined conditions is met (240), at least one related action is triggered (250). Once the one or more relevant actions are triggered, or if no condition is met, the method 200 returns to reception and storage of data tuples (210). Skilled persons will readily understand that the reception and storage of data tuples (210), in a preferred embodiment, is performed on an ongoing basis and that the reading or query (220) runs in a different process. Likewise, the triggered action (250) is likely managed, once triggered, by a different (e.g., dedicated) process. Examples of action triggered 250 include activation of an alarm siren or electric gate, logging of status from relevant emitter device(s) (e.g., presence, arrival, departure), message alert (e.g., post, tweet, short test text, email), law enforcement trigger, etc.

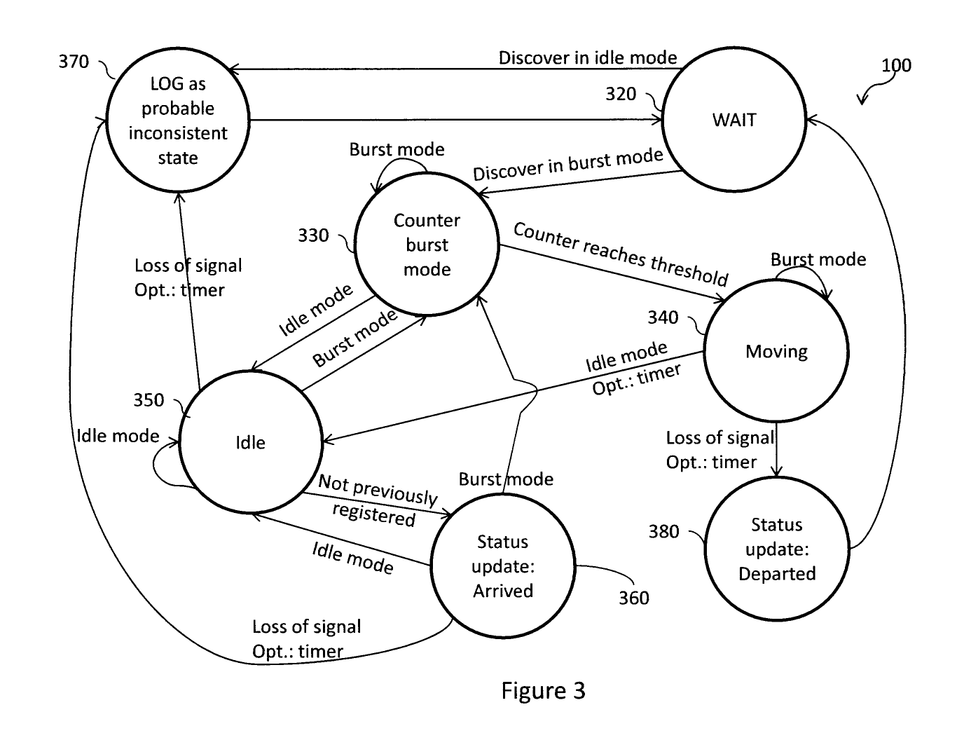

The analysis of the subset of data tuples 230 may be performed contextually using a finite state machine 300 as illustrated in the example of FIG. 3. The finite state machine (FSM) 300 shows an exemplary scenario for the monitored premise that involves a pool of emitter devices in or on vehicles (e.g., a car dealer inventory or a fleet of delivery vehicles). Skilled persons will understand that, based on the context, a “departed” or “moving” event does not have the same meaning and consequences in different contexts (e.g., normal for a fleet and abnormal for a car dealer). A state transition may trigger a notification to the user or to another device (not shown). In the example of FIG. 3, the analysis 230 is performed for a subset of data tuples related to a single emitter device over a period of time (i.e., one read or query for a period of time or a plurality of analysis steps 230 over a period of time). Conditions to transition from one state to another are based on one or more of the analysis step(s) 230. In the context of the example of FIG. 3, the monitored emitter device transmits data tuples periodically in idle mode when it does not detect movement (e.g., via its accelerometer or inertial sensor) and, upon detecting its movement, transmits in burst mode (short period) for a number of seconds.

The exemplary FSM 300 of FIG. 3 is initiated in a WAIT state (320). In the wait state 320, reception of data tuples in burst mode associated to the monitored emitter device without prior reception likely indicates that the monitored emitter device is arriving within range of a reader of the monitored premise. At this point, a date/time indication may be buffered (or otherwise kept) for the monitored emitter device to log as arrival time if the FSM 300 confirms the event. If real-time monitoring or reporting is required, an action (e.g. log, alert or message) could already be triggered. However, in the example of FIG. 3, it is expected that the monitored emitter device, if it is arriving, will be moving for a while before stopping. As such, the FSM 300 transitions to state 330 where a number of consecutive data tuples in burst mode are expected in order to minimize the likelihood of false movement detection (e.g., wind may have caused the vehicle to slightly move, which is unlikely to be a sustained condition). Once the counter reaches its threshold, the FSM 300 transitions to state 340 where the monitored emitter device is indicated as moving (e.g., likely subject to logging in memory module). A value of the counter threshold may be set based on needs of an environment in which it is used so that there is a minimal chance of false alarms. The FSM 300 remains in the state 340 as long as the monitored emitter device is in burst mode. If the monitored emitter device goes to idle mode, the FSM 300 transitions to the idle state 350. The transition may be made only after expiry of an optional timer to minimize the risk of the monitored emitter device being momentarily immobilized (e.g., gate registration prior to parking or delivery). Other conditions could be set instead of the timer to minimize the same risk (e.g., the reader device location that relayed the relevant data tuple(s) could indicate an expected location and, hence, an expected condition).

In the idle state 350, if the monitored emitter device is not registered as “arrived”, the FSM 300 transitions to the “arrived” state 360 where appropriate actions upon arrival of the monitored emitter device may be triggered (e.g., log of the date/time indication previously buffered. The log of the date/time indication previously buffered is used to obtain the time of the first transmission received. The “arrived” state 360 status update may simply be a condition set of the idle state 350 that would not require a specific state, but is shown on FIG. 3 for additional clarity. The “arrived” state 360 is followed by the idle state 350 once appropriate actions are triggered.

Once in the idle state 350 or the “arrived” state 360, a loss of signal likely indicates an abnormal condition. In fact, the monitored emitter device should be seen in burst mode and registered as moving before leaving the monitored premise. For greater certainty, an optional timer may be added to the loss of signal condition to minimize the risk of the monitored emitter device being simply “hidden” for one or more expected idle mode transmissions. If the loss of signal is detected (and, if relevant, confirmed by the timer), the FSM transitions to the probable “inconsistent” state 370 where appropriate actions may be triggered. The FSM then likely transitions to the wait state 320 for the monitored emitter device. Additional correlations may be made or specific reads or queries performed for the monitored emitter device before confirming an inconsistency.

In the example of FIG. 3, the FSM 300 remains in the idle state 350 as long as the monitored emitter device transmits data tuples in idle mode. Of course, it will be understood that other conditions (not shown) could be set on other aspects of the monitored emitter device (battery level, signal strength variations, etc.) to transition to additional not shown states of the FSM 300.

Upon reception of data tuple(s) in burst mode from the monitored emitter device, the FSM 300 transitions to the burst mode state 330, where the monitored emitter device may be marked as moving with condition(s) as previously indicated (or different condition(s) for an “arrived” monitored emitter device). In the moving state 340, a loss of signal likely indicates a departure. A date/time indication may be buffered or otherwise kept upon loss of signal. In the example of FIG. 3, in order to minimize the risk of the monitored emitter device being simply “hidden” for one or more expected burst mode transmissions, an optional timer is set before the FSM 300 transitions to the “departed” mode state 380. Appropriate actions are then taken in the “departed” state 380. For instance, a log may be made of the monitored device as “departed” as of the buffered date/time indication only if the monitored emitter device has been previously registered and otherwise mark the monitored emitter device as transiting into or close to the monitored premise. From the “departed” state 380, the FSM 300 transitions to the wait state 320. The “departed” state 380 status update may simply be a condition set of the moving state 340 that would not require a specific state, but is shown on FIG. 3 for additional clarity.

In a preferred embodiment, the analysis of the subset of data tuples 230 may take additional information into consideration such as, e.g., location of the receiver relaying the data tuples and signal strength for the monitored emitter device. An expected location of the monitored emitter device on the monitored premise could be determined by trilateration and/or signal strength. Linear regression or other statistical manipulation(s) of the information from the data tuples may be used to indicate a trend to improve the determination of the expected location (e.g., by removing some or all interference). The expected location can be used to indicate potential tampering (e.g., entry on the monitored device without registering through a “gate” antenna). If real-time monitoring is expected, the expected location also serves to provide contextual information and/or minimize the risk of false alerts. For instance, different antennas can be serialized to indicate a direction of movement, especially when considered with signal strength (“in” to “middle” to “out” antennas indicate departure while the reverse sequence indicates arrival).

The coverage of a tracked area of the monitored premise can be adjusted by tuning a signal strength threshold on the receiver and/or the emitter device, and may further be increased by using multiple receivers on the premise. When multiple receivers are used, filters may be used to avoid multiple storage of the same data tuple.

A plurality of emitter devices is typically active simultaneously in the tracking area of the premise. In order to further prevent tampering of the system, the analysis may also take into consideration the error rate in transmission (from noise in the signal or format of the data). For that purpose, the emitter device might also provide a redundancy check algorithm and add the redundant information to the transmitted data tuples or use encryption to prevent the data tuples from being imitated by a third party device.

Optionally, positioning of an emitter device's sin 3D space can be achieved by considering received signal strength indicator (RSSI) data. The positioning may thereafter serve to enable retrieval of an item, such as a car in a parking lot on several levels, a specific item in a warehouse with items stacked against each other, etc.

In order to provide the optional positioning, at least 3 antennas set along the X, Y, Z axis (e.g., two walls next to each other and ceiling) need to be provided. In the present example, if more than one antenna is provided on one or more of the axes, the data from the antennas with the strongest signal strength is used. Another option would be to consider the measurements from more than 3 antennas in the calculation. With the RSSI data and the knowledge of the antennas' positions relative to each other, the position of the emitter device is calculated within an expected precision of 1-10 meters. Since the data received from emitter devices is sensitive to outside interference, and therefore possibly “dirty”, linear data processing does not provide sufficient precision. Non-trivial random variations in the data collected are also expected. The following formulas present the model used to minimize the discrepancies.

RSSI[dbm]=−(10n log₁₀ d−A) where n: Signal attenuation constant, d: Distance from signal source and A: RSSI measured at 1 m (offset), which provides for the following distance calculation for a given antenna:

$$d [ m ] = {10}^{\frac{RSSI - A}{- 10 n}} . d [ m ]$$

and RSSI[dbm] are used to calculate the distance based on the signal strength and the antenna attenuation used. Several sets of data may be used, until the positioning is located, using a geometric median of those values for minimizing discrepancies.

A possible use of the positioning data obtained thereby is to present items with associated emitter devices on a graphical user interface together with their expected position or location (e.g., maps, lot number data, warehouse racking number, etc.). A user can select one or more items (in one or multiple selection steps) and send a request concerning the selection (e.g., order the item(s) or retrieve information concerning the item(s) via the graphical user interface). Also when a new item with an emitter device is placed into the environment, its location can be stored within the system (e.g., cataloged) without the need for manually entering its location.

The processor module may represent a single processor with one or more processor cores or an array of processors, each comprising one or more processor cores. The memory module may comprise various types of memory (different standardized or kinds of Random Access Memory (RAM) modules, memory cards, Read-Only Memory (ROM) modules, programmable ROM, etc.). The database may represent one or more logical or physical locations as well as a local or remote hard disk drive (HDD) (or an array thereof). The database may further represent a local or remote database made accessible through a network by a standardized or a proprietary interface. The network interface module represents at least one physical interface that can be used to communicate with other network nodes. The network interface module may be made visible to the other internal modules through one or more logical interfaces. The actual stacks of protocols used by the physical network interface(s) and/or logical network interface(s) of the network interface module do not affect the teachings of the present invention. The variants of the processor module, memory module, network interface module and database usable in the context of the present invention will be readily apparent to persons skilled in the art.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for triggering an appropriate action comprising:
successively receiving data tuples, sent from an emitter device, comprising an emitter identifier and a timestamp, wherein a period between the timestamps of two of the data tuples provides an indication on status of the emitter device;
storing the data tuples into a memory module;
reading a subset of the data tuples from the memory module;
analyzing the subset of the data tuples to identify a pre-determined condition; and
when the pre-determined condition is met, triggering the appropriate action.

2. The method of claim 1, wherein reading the subset of the data tuples comprises:
limiting the subset to an analysis period of time based on the timestamp; and
repeating the reading on a continuous basis;
wherein receiving the data tuples and storing the data tuples are performed on a continuous basis as long as the data tuples are received from the emitter device.

3. The method of claim 2, wherein the indication of status indicates movement of the emitter device and the period between the receptions of two of the data tuples is higher when the status of the emitter device is idle and the period is lower when the status of the emitter device is moving.

4. The method of claim 3, wherein the pre-determined condition is met when a number of consecutive data tuples from the subset during the analysis period of time are in the moving status.

5. The method of claim 4, wherein the appropriate action is to trigger an alarm event for the emitter device.

6. The method of claim 3, wherein:
the pre-determined condition is met when a number of consecutive data tuples from the subset during the analysis period of time are in the moving status followed by absence of data tuples in one or more of following subsets, the appropriate action comprising updating the status of the emitter device to “departed”;
the pre-determined condition is met when a number of consecutive data tuples from the subset during the analysis period of time are in the moving status followed by a number of data tuples in one or more of following subsets in the idle status, the appropriate action comprising updating the status of the emitter device to “arrived”; and
the pre-determined condition is met when a number of consecutive data tuples from the subset during the analysis period of time are in the idle status followed by absence of data tuples in one or more of following subsets, the appropriate action comprising updating the status of the emitter device to “inconsistent”.

7. The method of claim 1, further comprising granting an authorization request, the granted authorization request being considered in the analysis of the subset of the data tuples.

8. The method of claim 7, wherein at least one of the pre-determined condition or the appropriate action is received from a secured authentication module following the granted authorization request, wherein:
the granted authorization request is valid for a limited time;
the indication of status indicates movement of the emitter device and the period between the receptions of two of the data tuples is higher when the status of the emitter device is idle and the period is lower when the status of the emitter device is moving; and
wherein the pre-determined condition is met when a number of consecutive data tuples from the subset during the analysis period of time are in the moving status and the limited time elapses before renewal of the authorization request.

9. The method of claim 1, wherein the data tuples each further comprise a value derived from an accelerometer of the emitter device and a value derived from a battery meter of the emitter device.

10. The method of claim 1, further comprising filtering the received data tuples before storing the data tuples into the memory module.

11. The method of claim 1, wherein the reception of the data tuples sent from the emitter device is performed within a limited monitored premise by an antenna connected to a remote receiver using a low power wireless protocol, the remote receiver forwarding the data tuples over a packet switched network to a processing node that performs the storage, reading and analysis thereof.

12. The method of claim 1, wherein the received data tuples are further stored in a database and reading from the memory module further comprises querying the database, wherein the data tuples stored in the database are retrieved by the processing node.

13. A processing node for triggering an appropriate action comprising:
a filter module for successively receiving data tuples, each data tuple comprising an emitter identifier of an emitter device and a timestamp, wherein a period between the timestamps of two of the data tuples provides an indication on status of the emitter device;
a memory module for storing the data tuples; and
a correlation module for:
reading a subset of the data tuples from the memory module;
analyzing the subset of the data tuples to identify a pre-determined condition; and
when the pre-determined condition is met, triggering the appropriate action.

14. The processing node of claim 13, wherein the reading by the correlation module comprises:
limiting the subset to an analysis period of time based on the timestamp; and
repeating the reading on a continuous basis;
wherein receiving the data tuples and storing the data tuples are performed on a continuous basis as long as the data tuples are received from the emitter device.

15. The processing node of claim 14, wherein the indication of status indicates movement of the emitter device and the period between the receptions of two of the data tuples is higher when the status of the emitter device is idle and the period is lower when the status of the emitter device is moving.

16. The processing node of claim 15, wherein the pre-determined condition is met when a number of consecutive data tuples from the subset during the analysis period of time are in the moving status.

17. The processing node of claim 16, wherein the appropriate action is to trigger an alarm event for the emitter device.

18. The processing node of claim 15, wherein:
the pre-determined condition is met when a number of consecutive data tuples from the subset during the analysis period of time are in the moving status followed by absence of data tuples in one or more of following subsets, the appropriate action comprising updating the status of the emitter device to “departed”;
the pre-determined condition is met when a number of consecutive data tuples from the subset during the analysis period of time are in the moving status followed by a number of data tuples in one or more of following subsets in the idle status, the appropriate action comprising updating the status of the emitter device to “arrived”; and
the pre-determined condition is met when a number of consecutive data tuples from the subset during the analysis period of time are in the idle status followed by absence of data tuples in one or more of following subsets, the appropriate action comprising updating the status of the emitter device to “inconsistent”.

19. The method of claim 13, wherein the received data tuples are further stored in a database and reading from the memory module further comprises querying the database, the data tuples stored in the database being retrieved by the processing node.

20. A system for triggering an appropriate action comprising:
an emitter device for transmitting data tuples comprising an emitter identifier and a timestamp;
a reader for receiving the data tuples and transmitting the data tuples over a network; and
a processing node for:
successively receiving data tuples, wherein a period between the timestamps of two of the data tuples provides an indication on status of the emitter device;
analyzing a subset of the data tuples to identify a pre-determined condition; and
when the pre-determined condition is met, triggering the appropriate action.

21. The system of claim 20, wherein analyzing the subset of the data tuples comprises:
limiting the subset to an analysis period of time based on the timestamp; and
repeating the reading on a continuous basis;
wherein receiving the data tuples and storing the data tuples are performed on a continuous basis as long as the data tuples are received from the emitter device.

22. The system of claim 21, wherein the indication of status indicates movement of the emitter device and the period between the receptions of two of the data tuples is higher when the status of the emitter device is idle and the period is lower when the status of the emitter device is moving, wherein the pre-determined condition is met when a number of consecutive data tuples from the subset during the analysis period of time are in the moving status and wherein the appropriate action is to trigger an alarm event for the emitter device.

23. The system of claim 22, wherein:
the pre-determined condition is met when a number of consecutive data tuples from the subset during the analysis period of time are in the moving status followed by absence of data tuples in one or more of following subsets, the appropriate action comprising updating the status of the emitter device to “departed”;
the pre-determined condition is met when a number of consecutive data tuples from the subset during the analysis period of time are in the moving status followed by a number of data tuples in one or more of following subsets in the idle status, the appropriate action comprising updating the status of the emitter device to “arrived”; and
the pre-determined condition is met when a number of consecutive data tuples from the subset during the analysis period of time are in the idle status followed by absence of data tuples in one or more of following subsets, the appropriate action comprising updating the status of the emitter device to “inconsistent”.

24. The system of claim 20, further comprising a secured authentication module for granting an authorization request, the granted authorization request being considered in the analysis of the subset of the data tuples, wherein:
the granted authorization request is valid for a limited time;
the indication of status indicates movement of the emitter device and the period between the receptions of two of the data tuples is higher when the status of the emitter device is idle and the period is lower when the status of the emitter device is moving; and
wherein the pre-determined condition is met when a number of consecutive data tuples from the subset during the analysis period of time are in the moving status and the limited time elapses before renewal of the authorization request.

25. The system of claim 20, wherein the reader comprises an antenna connected to a remote receiver using a low power wireless protocol for receiving, within a limited monitored premise, the data tuples sent from the emitter device, the remote receiver forwarding the data tuples over a packet switched network to the processing node that performs the storage, reading and analysis thereof.
